(19) United States
(12) Patent Application Publication
(10) Pub. No.: US 2026/0144693 A1
(43) Pub. Date: May 28, 2026

(54) METHOD FOR TREATMENT OF LUMBAR INTERVERTEBRAL HERNIAS

(71) Applicant: Murat Maksutov, Almaty (KZ)

(72) Inventor: Murat Maksutov, Almaty (KZ)

(21) Appl. No.: 19/104,082

(22) PCT Filed: Feb. 27, 2024
(86) PCT No.: PCT/KZ2024/000007

§ 371 Date: Feb. 14, 2025

(51) Int. Cl. A61H 1/00

(52) U.S. Cl. CPC A61H 1/00

(57) ABSTRACT

The invention relates to the field of medicine, specifically neurology, traumatology, orthopedics, immunology, and therapy. In general, the invention pertains to medicine, particularly manual therapy and orthopedics. The invention is designed for diagnosing and correcting functional disorders of the spine and musculoskeletal system.
The object and technical result of the claimed invention is the use of manual therapy techniques for the treatment of intervertebral hernias in the lumbar region.
To address the above problems, we propose a method for the treatment of lumbar intervertebral hernias using manual therapy techniques, which method comprises mobilization of vertebrae and intervertebral tissues of the lumbar region in three planes (sagittal, frontal, and horizontal), repositioning of vertebral bodies in the L3-L4 and L4-L5 segments, wherein after pelvic fixation, additional one-stage pelvic repositioning is performed by rotating the sacrum and iliac bone wings under ultrasound control.
The method according to claim 1, wherein hernias ranging in size from 0.4 cm to 2.0 cm are treated.

The invention relates to the field of medicine, specifically neurology, traumatology, orthopedics, immunology and therapy. In general, the invention pertains to medicine, particularly manual therapy and orthopedics. The invention is designed for diagnosing and correcting functional disorders of the spine and musculoskeletal system.

Innovative patent RK No. 22736, published on Aug. 16, 2010, discloses a combined method for the prevention, treatment, and rehabilitation of the musculoskeletal system. This method involves the sequential application of the following procedures: phytotherapy, thermal therapy in the form of herbal compresses, ointments, and “cakes” containing bischofite, ozokerite, and paraffin; manual massage (both general and local); apparatus-based massage using vibromassagers and needle applicators; magnetotherapy, electrotherapy, manual therapy, acupuncture, acupressure, and therapeutic exercises. The method integrates these therapies into a single treatment session. The duration of a treatment session varies individually, ranging from 40 minutes to 1.5-2 hours, depending on the condition and its pathology. The treatment cycle lasts 5 to 10 days, considering the clinical form of the disease and the patient's response to massage. The decision to repeat the treatment cycle also depends on the disease pathology and may be made at intervals ranging from 1 to 6 months.

The document RU 2268700C2, published on Jan. 27, 2006, describes a method for manual diagnostics and correction of functional spinal conditions. This method involves palpation with the thumbs on both sides of the paravertebral muscles while the patient is standing or sitting. The examination is conducted at the levels of S1-L5, L3-L2, Th12-Th11, Th8-Th7, Th5-Th4, Th2-Th1, C5-C4, and C3-C2. The patient is instructed to bend forward or take a forced breath while seated or standing, without removing the thumbs. The asymmetry of muscle contractions is assessed based on thumb movement, allowing for the diagnosis of functional conditions of the spine, lower extremities, and pelvis. Correction is performed using an insole and/or buttock support, starting at 0.3-0.4 mm, to eliminate muscle contraction asymmetry.

Therefore, there is a need for further improvements in manual therapy method for musculoskeletal disorders.

The closest analog is document RU 2162312C1 , published on Jan. 27, 2001.

This document describes a method for treating herniated discs using manual therapy techniques.

The method comprises eliminating coccyx displacement, performing post-isometric relaxation of the lumbar spine extensors and lumbosacral muscles, mobilizing the vertebrae and intervertebral tissues of the lumbar spine, eliminating flexion and extension contractures in the knee joints, distracting tissues between the sacrum and thoracic spine, as well as between the iliosacral joints and hip joints, correcting sacral rotation and caudal displacement of the iliac bones, and applying jerk distraction of the lumbar spine with simultaneous local pressure on the ventral region of the lumbosacral joint, in the projection of the anterior surface of the lumbar spine or the area of pain projection, followed by strengthening the muscles of the pelvis, spine, and lower extremities.

The disadvantage of the closest analog is the absence of one-stage repositioning. In the proposed method of the invention, one-stage repositioning of the pelvis is performed by rotating the sacrum and iliac bone wings, as well as repositioning the L1, L4, and L5 vertebral bodies from retrolisthesis through rotational displacement of said vertebral bodies in the sagittal, frontal, and horizontal planes.

### Key Facts

Approximately 1.71 billion people worldwide suffer from musculoskeletal disorders and diseases.
Lumbago accounts for the largest share of the musculoskeletal disease burden, affecting 568 million people globally.
Musculoskeletal disorders and diseases are the leading cause of disability worldwide, with lumbago being the primary cause of disability in 160 countries.
These conditions significantly limit mobility and motor function, leading to premature loss of working capacity, reduced well-being, and fewer opportunities for social participation.
Due to population growth and aging, the number of people affected by musculoskeletal disorders and diseases is rapidly increasing.
The disability burden caused by these diseases continues to rise, and projections indicate that this trend will persist for decades to come.

### Scope of the Problem

Musculoskeletal disorders and diseases encompass over 150 conditions affecting the musculoskeletal system. These range from acute, short-term issues such as fractures, sprains, and strains to chronic, lifelong impairments that result in permanent functional decline and disability. Typically, musculoskeletal disorders and diseases are characterized by pain (often of a permanent nature), reduced mobility, and deterioration of motor function and overall functional abilities, significantly limiting a person's capacity to work.

Musculoskeletal disorders and diseases affect various components of the musculoskeletal system, including:
joints, particularly osteoarthritis, rheumatoid arthritis, psoriatic arthritis, gout, and ankylosing spondylitis.
bone tissues, particularly osteoporosis, osteopenia, and fractures related to bone fragility or trauma.
muscles, particularly sarcopenia.
spine, particularly lumbago and cervicalgia.
multiple body regions or systems, particularly regional and widespread pain syndromes, as well as inflammatory diseases such as connective tissue disorders and vasculitis, both of which may present with musculoskeletal symptoms, and systemic lupus erythematosus.

Additionally, musculoskeletal disorders and diseases are a major factor driving the global demand for rehabilitation services. They are among the primary reasons for rehabilitation needs in children, while approximately two-thirds of adults requiring rehabilitation services suffer from musculoskeletal disorders and diseases.

The method of the invention has proven its effectiveness in a group of patients with various musculoskeletal system diseases:
1. S-shaped scoliosis of I-III grade
2. Joint biomechanical disorders (elbow, knee, and hip)
3. Pelvic misalignment
4. High compression pressure (disc protrusion, herniated disc), lumbar radiculopathy (radicular syndrome) due to reflex conflict
5. Vertebrobasilar insufficiency (VBI)—a disorder of brain function caused by impaired blood flow in the basilar or vertebral arteries from 2012 to 2022. As a result of this manual therapy, confirmed by MRI images before and after the procedure and combined therapy, five patients reported an immediate reduction in pain intensity according to the Visual Analog Scale (VAS) from 8 to 4-5 points. Additionally, control MRI studies showed a significant reduction in disc herniation size, decreasing by 2 to 4 times.

The method of the invention is applicable to various intervertebral disc conditions not directly caused by spinal fractures or contusions. Before manual therapy, manual muscle testing is performed according to Dr. Maksutov's method.

The method of the invention comprises one-stage pelvic repositioning by rotating the sacrum and iliac bone wings in three planes (sagittal, frontal, and horizontal) under ultrasound control. During manual therapy, repositioning of the L1, L4, and L5 vertebral bodies from retrolisthesis is achieved through rotational displacement in the sagittal, frontal, and horizontal planes. The method eliminates rotational displacement of L1, L4, and L5 vertebral bodies. It also modifies the kyphotic arch angle of the thoracic spine at T5-T6-T7-T8 and T11-T12, reducing compression pressure on the lumbar intervertebral discs. This, in turn, decreases disc prolapse into the spinal canal due to the “vacuum effect”, providing an immediate reduction of pain by half according to the VAS scale.

Patient with pain syndrome and restricted neck rotation, pain and numbness in the hands, pain in the shoulder region and over the shoulders, with an intensity of VAS 6-7. Method:
Manual muscle testing was performed. Kyphotic deformity of the cervical spine was corrected by eliminating anterolisthesis of T1, T2, T3 vertebral bodies, which caused kyphotic displacement of C3, C4, C5, and C6 cervical vertebral bodies. Rotational displacement of all cervical vertebrae was eliminated, and repositioning of said vertebrae along the sagittal, frontal, and horizontal axes was performed under ultrasound guidance and control, restoring cervical lordosis. As a result of the author's manual therapy, pain intensity immediately decreased to 4 points on the VAS scale.

This manual therapy was also applied in a case of congenital pelvic misalignment in a pediatric patient, with a difference in acetabular angles of 7-8 degrees. Incomplete immersion of the left femoral head was detected. During manual therapy, repositioning of the pelvic and sacral bones was performed along a zero vector, ensuring complete immersion of the left femoral head. Following the procedure, the acetabular angle difference was reduced to 1 degree, as confirmed by control radiographs. As a result of this manual therapy, pelvic misalignment was corrected, pain syndrome was immediately relieved, and the patient began walking without limping.

Based on the above clinical cases performed under ultrasound control, the author's method of manual therapy is proposed for use in the treatment of various musculoskeletal system diseases, spinal hernias, pain syndrome of the spine, and pelvic misalignment. This method has demonstrated high effectiveness in patients of different age groups compared to the standard treatment protocol. It enables the effective treatment of hernias ranging in size from 0.4 cm to 2.0 cm without surgical intervention and without subsequent recurrence. Pain syndrome is immediately relieved, allowing the patient to quickly return to their usual lifestyle without social or psychological stress.

The object and technical result of the claimed invention is the application of the author's method of manual therapy for the treatment of various musculoskeletal system diseases, spinal hernias, pain syndrome of the spine, and pelvic misalignment. This method has demonstrated high effectiveness in patients of different age groups compared to the standard treatment protocol. It enables the effective treatment of hernias ranging in size from 0.4 cm to 2.0 cm without surgical intervention and without subsequent recurrence. Pain syndrome is immediately relieved, allowing the patient to quickly return to their usual lifestyle without social or psychological stress.

To address the above problems, a manual therapy method is proposed for the treatment of musculoskeletal system diseases, which method comprises one-stage pelvic repositioning by rotating the sacrum and iliac bone wings in three planes under ultrasound control. During manual therapy, repositioning of the L1, L4, and L5 vertebral bodies from retrolisthesis is achieved through rotational displacement along the sagittal, frontal, and horizontal axes, with complete elimination of rotational displacement of L1, L4, and L5 vertebral bodies. The method also comprises adjusting the kyphotic arch angle of the thoracic spine at T5-T6-T7-T8 and T11-T12, reducing compression pressure on the lumbar intervertebral discs. This, in turn, decreases disc prolapse into the spinal canal cavity due to the “vacuum effect”, resulting in an immediate reduction of pain by half according to the VAS scale.

The invention is illustrated by the following drawings:

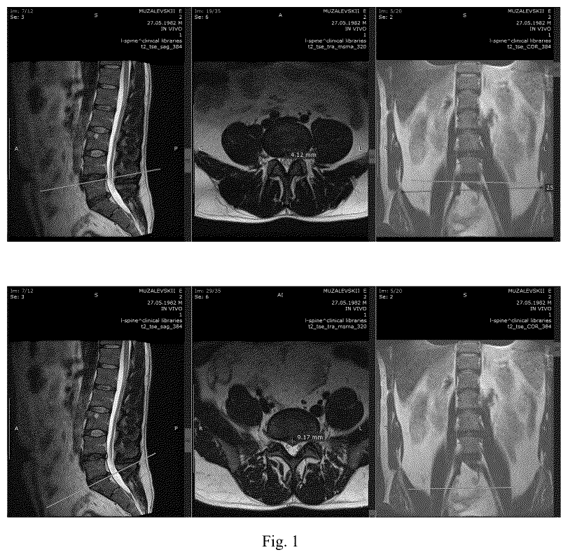

FIG. 1. Lumbar spine image of Patient No. 1, Patient M, before the treatment.

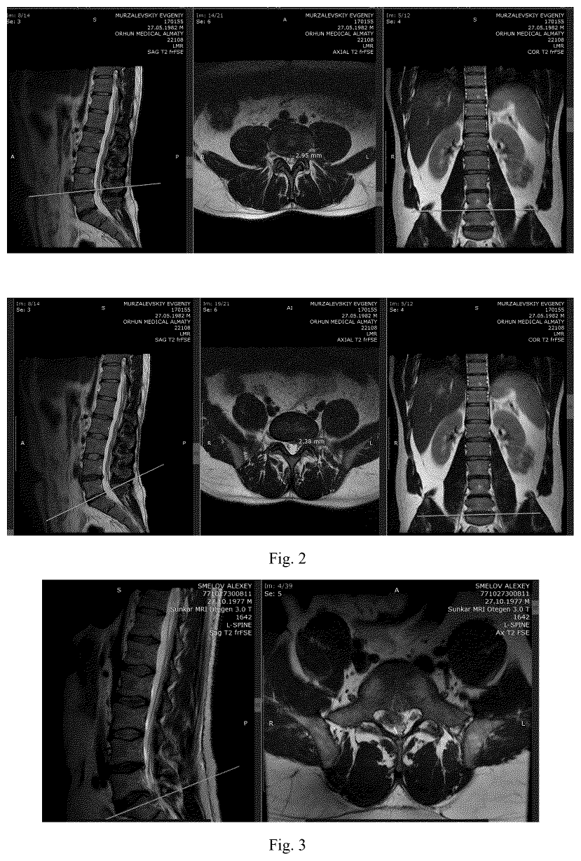

FIG. 2. Lumbar spine image of Patient No. 1, Patient M, after the treatment.

FIG. 3. Lumbar spine image of Patient No. 2, Patient C, before the treatment.

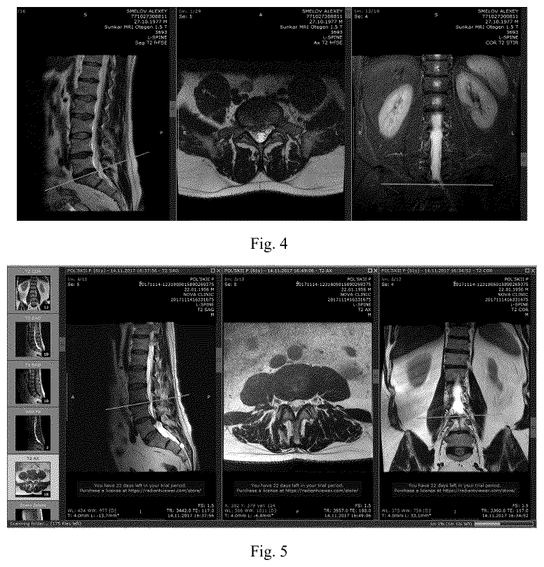

FIG. 4. Lumbar spine image of Patient No. 2, Patient C, after the treatment.

FIG. 5. Lumbar spine image of Patient No. 3, Patient P, before the treatment (MRI study before the treatment, November 2017).

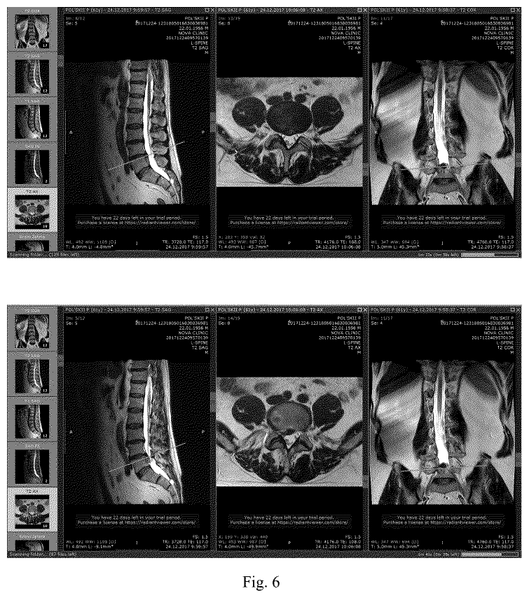

FIG. 6. Lumbar spine image of Patient No. 3, Patient P, interim MRI study (December 2017), 1 month after the treatment.

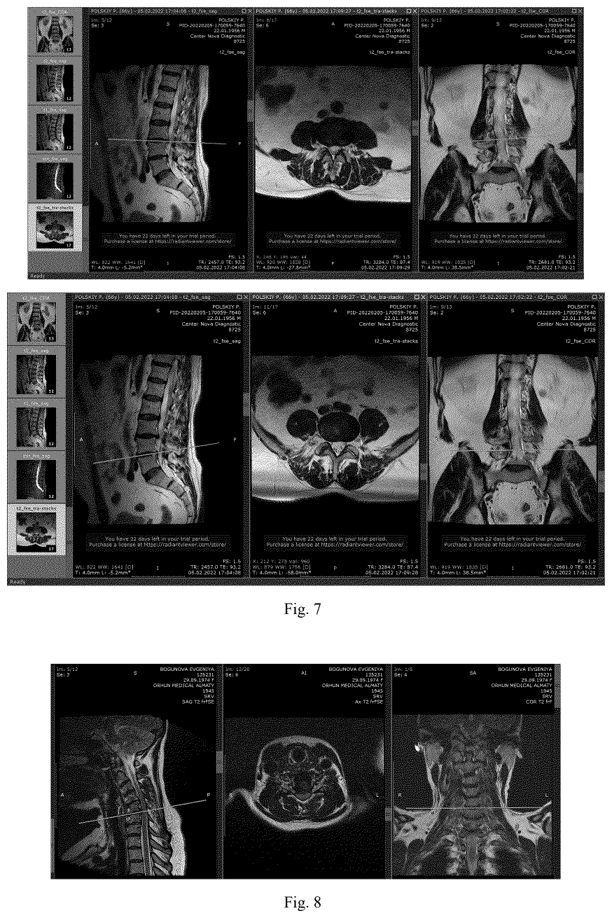

FIG. 7. Lumbar spine image of Patient No. 3, Patient P, after the treatment (MRI control study, February 2022). No clinical complaints.

FIG. 8. Cervical spine image of Patient No. 4, Patient J, before the treatment (MRI study, May 5, 2020, before the treatment).

FIG. 9. Cervical spine image of Patient No. 4, Patient J, after the treatment (interim MRI study following the first treatment cycle, Nov. 21, 2020).

FIG. 10. Cervical spine image of Patient No. 4, Patient J, after the treatment (MRI study, Nov. 16, 2021, after the treatment).

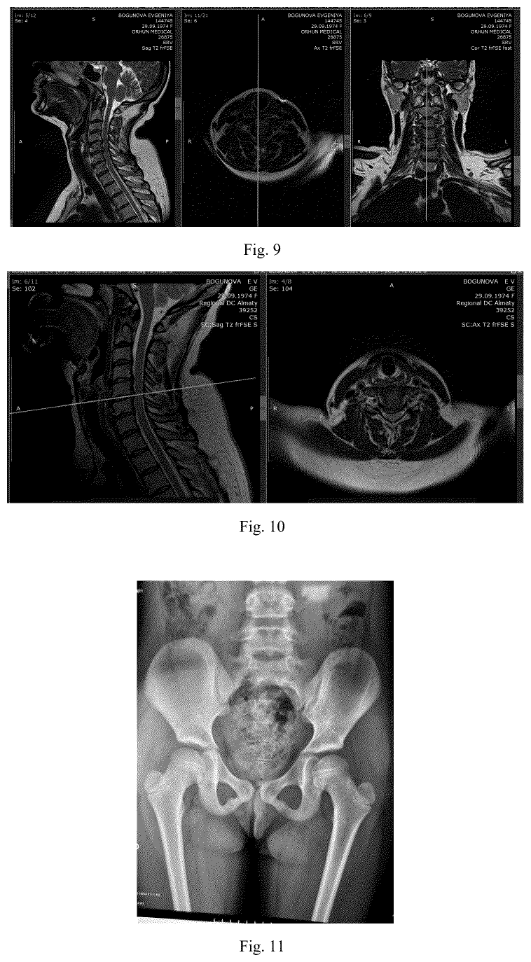

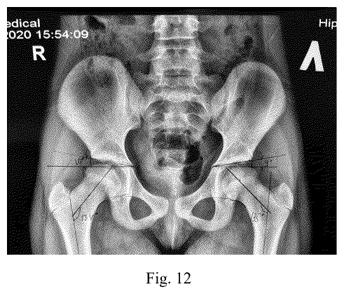

FIG. 11. Hip joint image of Patient No. 5, Patient D, before the treatment.

FIG. 12. Hip joint image of Patient No. 5, Patient D, after the treatment.

### EXAMPLES OF EMBODIMENTS OF THE INVENTION

Case No. 1. Patient M., born in 1982, was admitted with complaints of lumbar spine pain radiating to the right leg along the posterior surface (in the S1 root innervation area). The patient also reported numbness in the right shin and foot. The intensity of the pain syndrome was 8 points according to the VAS scale. See FIG. 1—Lumbar spine image of Patient No. 1, Patient M, before the treatment.

A treatment cycle was performed:

Method: Manual muscle testing was conducted. One-stage pelvic repositioning was performed by rotating the sacrum and iliac bone wings in three planes (sagittal, frontal, and horizontal). Repositioning of the L1, L4, and L5 vertebral bodies from retrolisthesis was achieved through rotational displacement of said vertebral bodies along the sagittal, frontal, and horizontal axes, with complete elimination of rotational displacement in these vertebrae. The procedure also included adjusting the kyphotic arch angle of the thoracic spine at T5-T6-T7-T8 and T11-T12, thereby reducing compression pressure on the lumbar intervertebral discs. This, in turn, minimized disc prolapse into the spinal canal cavity due to the “vacuum effect”.

As a result, the intensity of the pain syndrome decreased to 4-5 points according to the VAS scale.

Additionally, the following were recommended: non-steroidal anti-inflammatory drugs (NSAIDs); intratissual electric stimulation (ITES)—2 treatment cycles, 5 procedures per cycle (pain syndrome was eliminated, sensory disorders regressed); course of therapeutic exercises (TE) on the REDCORD suspended rehabilitation simulator system (no recurrence of pain syndrome was observed).

Control MRI scan (5 months post-treatment): L4-L5 disc herniation size decreased by 2 times; L5-S1 disc herniation size decreased by 3 times. See FIG. 2—Lumbar spine image of Patient No. 1, Patient M, after the treatment.

Case No. 2. Patient S., born in 1977, was admitted with complaints of lumbar spine pain radiating to the right leg along the posterior surface (in the S1 root innervation area). The patient also reported numbness on the anterior surface of the right thigh (in the external cutaneous nerve innervation area) and numbness in the fifth toe of the right foot. The intensity of the pain syndrome was 7-8 points according to the VAS scale. See FIG. 3—Lumbar spine image of Patient No. 2, Patient C, before the treatment.

A treatment cycle was performed:

Method: Manual muscle testing was conducted. The procedure was performed under ultrasound control and included one-stage pelvic repositioning by rotating the sacrum and iliac bone wings in three planes (sagittal, frontal, and horizontal). Repositioning of the L1, L4, and L5 vertebral bodies from retrolisthesis was achieved through rotational displacement of said vertebral bodies along the sagittal, frontal, and horizontal axes, with complete elimination of rotational displacement in these vertebrae. The kyphotic arch angle of the thoracic spine at T5-T6-T7-T8 and T11-T12 was adjusted, which reduced compression pressure on the lumbar intervertebral discs. This, in turn, minimized disc prolapse into the spinal canal cavity due to the “vacuum effect”. Additionally, the angular relationship was corrected between the base of the sacrum and the L5 vertebra, as well as between the top of the sacrum and the base of the coccyx, effectively minimizing the gravitational vector magnitude.

As a result, the intensity of the pain syndrome decreased to 4-5 points according to the VAS scale.

Additionally, the following were recommended: NSAIDs; ITES therapy—2 treatment cycles, 7 procedures per cycle; blockades with platelet-activated autoplasma—5 procedures at 10-day intervals (pain was eliminated, sensory disorders regressed).

Control MRI scan (3 months post-treatment): hernia size reduced 4-fold. See FIG. 4 Lumbar spine image of Patient No. 2, Patient C, after the treatment.

Case No. 3. Patient P., born in 1956. Diagnosed with a prolapsed herniated disc at L4-L5 (right side), presenting with lumbar spine pain radiating to the right leg along the outer surface of the thigh and shin, as well as weakness in right foot extension (up to 3 points) in the L5 root innervation area. Additionally, the patient reported numbness in the right shin and foot. The intensity of the pain syndrome was 8-9 points according to the VAS scale.

A treatment cycle was performed:

Manual muscle testing was conducted. The procedure was performed under ultrasound control and included one-stage pelvic repositioning by rotating the sacrum and iliac bone wings in three planes (sagittal, frontal, and horizontal). Repositioning of the L1, L4, and L5 vertebral bodies from retrolisthesis was achieved through rotational displacement of said vertebral bodies along the sagittal, frontal, and horizontal axes, with complete elimination of rotational displacement in L4 and L5 vertebral bodies. The kyphotic arch angle of the thoracic spine at T5-T6-T7-T8 and T11-T12 was also adjusted, which reduced compression pressure on the lumbar intervertebral discs. This, in turn, minimized disc prolapse into the spinal canal cavity due to the “vacuum effect”.

As a result, pain intensity decreased to 3-4 points according to the VAS scale.

Medication therapy with anti-inflammatory and anti-edema agents for 7 days resulted in further pain regression to 2-3 points.

MRI study (November 2017, before the treatment): See FIG. 5—Lumbar spine image of Patient No. 3, Patient P, before the treatment.

Interim MRI study (December 2017, 1 month after the treatment): The herniation size remained, but the “density” of the disc fragment significantly decreased, indicating that the herniation became “softer”. See FIG. 6—Lumbar spine image of Patient No. 3, Patient P, 1 month after the treatment.

Control MRI study (February 2022): No clinical complaints. The disc fragment was lysed, and there were no signs of spinal cord root compression. See FIG. 7—Lumbar spine image of Patient No. 3, Patient P, after the treatment.

Case No. 4. Patient J., born in 1974. Presented with pain and restricted neck rotation, pain and numbness in the hands, and pain in the shoulder region and over the shoulders. The intensity of the pain syndrome was 6-7 points according to the VAS scale.

A treatment cycle was performed:

Manual muscle testing was conducted. Under ultrasound control, the procedure was performed to correct kyphotic deformity of the cervical spine by:
1. Eliminating anterolisthesis of T1, T2, and T3 vertebral bodies, which caused the kyphotic displacement of C3, C4, C5, and C6 cervical vertebral bodies.
2. Eliminating rotational displacement of all cervical vertebrae and performing repositioning of said vertebrae along the sagittal, frontal, and horizontal axes under ultrasound guidance, thereby restoring cervical lordosis.

As a result, the intensity of the pain syndrome decreased to 4 points according to the VAS scale.

Additionally, the following were recommended: NSAIDs; ITES therapy—2 treatment cycles, 7 procedures per cycle; blockades with platelet-activated autoplasma (pain syndrome was eliminated, and sensory disorders regressed); course of therapeutic exercises on the REDCORD suspended rehabilitation simulator system.

MRI studies:

May 5, 2020 (before the treatment): See FIG. 8—Cervical spine image of Patient No. 4, Patient J, before the treatment.

Nov. 21, 2020 (interim, after the first treatment cycle): See FIG. 9—Cervical spine image of Patient No. 4, Patient J, after the treatment.

Nov. 16, 2021 (post-treatment): See FIG. 10—Cervical spine image of Patient No. 4, Patient J, after the treatment.

Case No. 5. Patient D., 9 years old. Presented with pain in the left hip joint, limping on the left side, and left leg skidding sideways while walking.

Radiographic findings: Congenital pelvic misalignment with an acetabular angle difference of up to 7-8 degrees and incomplete immersion of the left femoral head. See FIG. 11—Hip joint image of Patient No. 5, Patient D, before the treatment.

Repositioning was performed by adjusting the pelvic and sacral bones along a zero vector, achieving full immersion of the left femoral head. Control radiography: Acetabular angle difference reduced to 1 degree. Pelvic misalignment was corrected.

Clinical outcome: Pain was immediately relieved, and the child walked without limping. See FIG. 12—Hip joint image of Patient No. 5, Patient D, after the treatment.

We claim:

1. A method for the treatment of lumbar intervertebral hernias using manual therapy techniques, which method comprises mobilization of vertebrae and intervertebral tissues of the lumbar region in three planes (sagittal, frontal, and horizontal), repositioning of vertebral bodies in the L3-L4 and L4-L5 segments, wherein after pelvic fixation, an additional one-stage pelvic repositioning is performed by rotating the sacrum and iliac bone wings under ultrasound control.

2. The method according to claim 1, wherein hernias ranging in size from 0.4 cm to 2.0 cm are treated.
